(19) United States
(12) Patent Application Publication
(10) Pub. No.: US 2024/0085620 A1
(43) Pub. Date: Mar. 14, 2024

(54) CASCADED FINITE IMPULSE RESPONSE DEMODULATOR

(71) Applicants: KEITH J. WILLIAMS, Dunkirk, MD (US); Jason McKinney, West Lafayette, IN (US); John F. Diehl, Clinton, MD (US); John M. Singley, Elysburg, PA (US)

(72) Inventors: KEITH J. WILLIAMS, Dunkirk, MD (US); Jason McKinney, West Lafayette, IN (US); John F. Diehl, Clinton, MD (US); John M. Singley, Elysburg, PA (US)

(21) Appl. No.: 17/901,983

(22) Filed: Sep. 2, 2022

(51) Int. Cl. G02B 6/12; G02F 1/21

(52) U.S. Cl. CPC G02B 6/12004; G02B 6/12007; G02F 1/21

(57) ABSTRACT

An apparatus includes a finite impulse response demodulator. The finite impulse response demodulator includes least one stage. Each stage includes a cascaded pair of interferometers. The cascaded pair of interferometers includes a first interferometer and a second interferometer. Optionally, the first interferometer includes a first delay. The second interferometer includes a second delay. The first delay and the second delay are fixed or variable. Optionally, the first delay is unequal or equal to said second delay. Optionally, the first interferometer includes first internal power monitors, and the second interferometer includes second internal power monitors. The first power monitors monitor phase bias conditions within the first interferometer. The second power monitors monitor phase bias conditions within the second interferometer. Optionally, the first interferometer includes a first adjustable coupler, and the second interferometer comprises a second adjustable coupler. The second adjustable coupler communicates with the first interferometer.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing NC 111696-US1.

### BACKGROUND OF THE INVENTION

### Field of the Invention

This invention relates in general to a demodulator, and in particular to an optical demodulator.

### Description of the Related Art

For over 40 years, the analog photonics community has pursued a low noise figure optical link. After improvements in modulator efficiency and increased optical powers/photodetector currents, noise figures below 10 dB are still just laboratory demonstrations as optical power losses and modulator efficiencies are still too high. Until photonic links can routinely achieve noise figures below 10 dB, widespread adoption will be challenging. The move towards Photonic Integrated Circuits (“PICs”) will not address this problem without significant innovation as one of the main approaches (i.e., via high currents) to achieving low noise figure is challenging to achieve in an integrated platform.

Public sector systems are quickly expanding in bandwidth as the use of the electromagnetic spectrum expands from the traditional frequency bands below 18 GHz to frequencies up to and exceeding 110 GHz. The rapid advancement of electronic integrated circuits has enabled even the unsophisticated adversary the ability to design highly effective systems that can operate outside of these traditional frequency bands. Analog photonics in the form of fiber optics and discrete components have shown much promise in dealing with this bandwidth problem. However, the analog performance of even fiber optic solutions for these problems are just now beginning to have the necessary RF performance to meet public sector system needs. The performance of analog fiber optic versions of these systems fabricated using PICs is even further behind that of versions based on discrete fiber-based optical components. This is rooted in the lower performance available from the individual integrated devices that make up an optical link. For this technology to be widespread within RF systems, the noise figure of optical links must be consistently below 10 dB up to 100 GHz.

FIG. 1 shows a block diagram of a prior art external-intensity-modulated fiber optic link 10, the building block of many analog RF systems that utilize fiber optics. The external-intensity-modulated fiber optic link 10 includes a block labeled “k” that represents a standard continuous wave (“CW”) laser source 0.

The CW laser source 0 produces carrier signal having a wavelength λ. The external-intensity-modulated fiber optic link 20 further includes a block labeled “Mod” that represents a standard external intensity modulator 30. The carrier signal of the CW laser source 20 is intensity-modulated by the external intensity modulator 30 with an input RF signal (labeled “RF In” in FIG. 1). The optical signal, comprising the carrier signal intensity-modulated by the input RF signal, is transported over a standard optical fiber 40 to a photodetector 50. The photodetector is represented by block “PD” in FIG. 1. The photodetector 50 converts the optical signal back to an RF signal. The RF gain of the link in FIG. 1 is determined by only two parameters, the efficiency, Vπ, of the external modulator 30 denoted by the voltage required to induce a π-phase shift of the light in the external modulator 30 and the photocurrent at the output, which is function of the power in the CW laser source 20, the optical losses inherent in the intensity-modulated optical link 10, and the quantum efficiency of the output photodetector 50. The small-signal gain of the intensity-modulated optical link 10 is expressed as:

$$g = {[ \frac{π {I}_{dc , q}}{{V}_{π}} ]}^{2} {R}_{i} {R}_{o} {\vert {II}_{pd} \vert}^{2} \qquad ( 1 )$$

where I_{dc,q} is the DC photocurrent at quadrature, Rᵢ and Rₒ are the input and output resistances of the link and H_{pd} is the frequency response transfer function of the photodiode. If the link gain is plotted as a function of the total received photocurrent for various modulator efficiencies (Vpi), when the output photodiode contains a 50 Ohm parallel resister to achieve a good RF output impedance match, the trend to achieving gain is to both decrease the modulator efficiency Vpi and to increase the detected photocurrent. In fiber optic versions of intensity-modulated optical link 10, link gains greater than unity (0 dB) are readily achieved at microwave frequencies.

The noise figure of intensity-modulated optical link 10 is usually the most important metric that is considered in link design. Noise degrades signal fidelity and degrades the ability to process the signals further. If the noise figure of intensity-modulated optical link 10 is plotted versus photocurrent for various modulator efficiencies (Vpi), for similar reasons as link gain, the noise figure is shown to generally decrease as the modulator Vpi decreases and as the detected photocurrent increases. However, when relative intensity noise (“RIN”), i.e., noise of the optical intensity of CW laser source 20, normalized to its average value, is included, eventually the noise figure approaches a minimum, the value of which increases with higher levels of RIN.

When the degradation in noise figure performance due to the added laser RIN is plotted, the degradation is reasonably independent of modulator Vpi, as RIN manifests itself as added noise in the output RF signal, independent of modulator efficiency, until the intensity-modulated optical link 10 achieves a very low noise figure. Standard semiconductor lasers achieve RIN values in the −155 to −165 dBc/Hz range or worse, depending on frequency. Laser RIN is therefore an important factor to consider in achieving low noise figures.

One solution to mitigate the effects of laser RIN is to cancel it in the output of a balanced link. FIG. 2 shows an example of a prior art balanced optical link 100. Balanced optical link 100 includes a standard dual-output (i.e., complementary) modulator 160, which provides outputs that are 180 degrees out of RF phase. Both signals are then propagated down two identical standard optical fibers 140, 142, the outputs of which are subtracted in a standard balanced pair of photodiodes, labeled as box “Bal PD” 170 in FIG. 2. Because the laser RIN is common-mode and the RF signal of interest is complementary, the subtraction process suppresses the effects of RIN by an amount determined by the amplitude and phase match of the two paths. it is typical to achieve 20 to 30 dB of common-mode rejection; however, in long delay lines, this requires two identical length fibers. As a practical matter, identical lengths in the two identical standard optical fibers 140, 142 is difficult to implement for long delays and at higher frequencies, wherein environmental drifts cause dynamic phase mismatches, e.g., due to thermal mismatches in the two propagation paths.

Arraying optical links are also used to increase performance metrics. For example, an arrayed optical link configuration includes arrayed photodetectors to increase link gain. In the arrayed optical link configuration, a single modulator is split into many photodetectors, and depending on the recombination method, results in higher link gain. Recombination implementations following the arrayed photodetectors include 1) an implementation employing a standard RF splitter and hard wiring the multiple photodetectors together; and 2) wave-division multiplexing.

Phase modulation with a differential delay line demodulator as an alternative to intensity modulation is also used to increase performance metrics. FIG. 3 shows an implementation of a prior art phase-modulated optical link 200 with a unbalanced Mach-Zehnder (“MZI”) 210 used as a demodulator to turn phase modulation into intensity modulation to allow for photodetection as standard photodetectors 250, 252 only convert intensity into current. The link gain for a phase modulation link, when the MZI 210 is biased at quadrature, is:

$$g = {[ \frac{2 π {I}_{dc , q} sin ( π f τ )}{{V}_{π}} ]}^{2} {R}_{i} {R}_{o} {\vert {H}_{pd} \vert}^{2} \qquad ( 2 )$$

which is very similar to equation (1) with 2 distinct differences. The first difference is the factor of sin²(πfτ) which is due to the differential delay within the MZI 210 that gives rise to a periodic response in the frequency domain. The second difference is the factor of 2 which leads a net gain of 6 dB over an intensity-modulated optical link 10 of FIG. 1, when sin² (πfτ)=1, or equivalently only at the frequency at which the response is at its maximum. The gain for an illustrative phase-modulated optical link 200 peaks at 1.33 GHz and every 2.67 GHz thereafter when the differential delay τ=375 nanoseconds. It is at these frequencies that the link gain is 6 dB higher than that of an intensity-modulated link 10. The −3 dB instantaneous bandwidth of illustrative phase-modulated optical link 200 is equal to 100% of the center frequency, or 1.33 GHz, centered on 1.33 GHz which is equal to one octave.

Relative to the noise figure of the phase-modulated optical link 200 with an unbalanced MZI 210 as a demodulator, it is important to understand that the shot noise at the output of this link. is “white.” That is, the filtering effect associated with the unbalanced MZI 210 that creates such a distinctive periodic response in the gain (proportional to sin²(πfτ)) does not manifest itself as any frequency dependence in the shot noise. This is due to the fact that shot noise is due to the random arrival of a photon, which is not influenced by the exact path that the photon takes to get to the photodetector. Thus, the noise figure of the phase-modulated optical link 200 in the shot noise limit is 6 dB lower than an intensity-modulated optical link 10 at the frequency where the gain peaks and increases by 1/sin² (πfτ) over frequency. Achieving the shot noise limit requires a laser with a relative intensity noise level (similar to that needed by intensity-modulated optical link 10), but also with low phase noise since the laser phase noise will be converted into amplitude noise by the unbalanced MZI 210. Lasers with kHz linewidths allow for these links to achieve the shot noise limit at microwave frequencies for reasonable photocurrents.

To derive the small signal gain for a phase-modulated optical link 200 with a MZI demodulator 210, one needs to understand the function of the components that make up the link and the demodulator. This mathematical background relies on the fact that the 50/50 optical couplers 260, 262 used in the MZI 210 act on the electric field and not the optical intensity. FIG. 4 illustrates a mathematical description of one such 50/50 coupler 260. 50/50 (equal splitting ratio between the two outputs) couplers are mathematically equivalent to a 90 degree “hybrid” in the RF domain, wherein the electric field that enters one fiber splits into two parts with the cross-coupled field being multiplied by j, the complex number equal to the square root of (−1). The electric field output of the MZI demodulator can he expressed by a 2×2 matrix equation given by:

$$( \begin{matrix}{E}_{1} ( t ) \\ {E}_{2} ( t )\end{matrix} ) = \frac{1}{2} ( \begin{matrix}1 & j \\ j & 1\end{matrix} ) ( \begin{matrix}Γ ( τ ) & 0 \\ 0 & 1\end{matrix} ) ( \begin{matrix}1 & j \\ j & 1\end{matrix} ) ( \begin{matrix}{E}_{0} ( t ) \\ 0\end{matrix} ) \qquad ( 3 )$$

where a single input electric field, E₀(t), is considered and where Γ(τ) is a time delay operator where Γ(τ) E₀(t)=E₀(t−τ). To derive the small signal gain, one needs to use equation (3) to calculate E from which one can calculate the intensity by calculating EE*. That intensity gets converted to the output current by the photodetector from which one can calculate the output RF power and then ratio that output RF power with the input RF power of the link to get the desired gain.

### SUMMARY OF THE INVENTION

An embodiment of the invention is advantageously used in fiber-optic transmission systems for analog radio frequency (“RF”) applications. This embodiment of the invention provides improved efficiency and bandwidth programmability of phase-modulated optical links. These improvements make such systems more attractive for RF applications and enable widespread use of photonic integrated circuits for analog RF applications.

An embodiment of the invention concerns the transmission, and processing of electrical signals using an optical carrier. In particular, this embodiment of the invention concerns efficiently demodulating a phase modulated optical carrier. This embodiment of the invention includes an apparatus to improve the efficiency of an optical link by using a multitude of finite impulse response filters together to yield an optical link that outperforms the performance of a traditional phase- or intensity-modulation optical links that utilize a single transmission fiber at the expense of operation over a narrower, but technically meaningful bandwidths. In addition, this invention will address the ability to alter the intended bandwidth or frequency of operation by incorporating programmable optical elements. This invention will improve the efficiency of an optical link, providing a wider adoption of the technology into both government and commercial applications. Improvements are expected in links utilizing discrete fiber optic components, but especially important for links constructed from photonic integrated circuits (“PTCs”) where circuit densities can be much higher and optical power comes at a premium.

An embodiment of the invention decreases optical losses by using novel optical finite impulse response filters to combine the outputs of a typical optical modulator into a unitary single mode optical waveguide for propagation and ultimately illumination on a single photodiode. This invention provides a key solution for high frequency links as high-efficiency detection can occur in a single photodiode which is more optimal to maintain bandwidth over multi-photodiode detection receivers.

An embodiment of the invention provides a unique and substantial improvement to the noise figure of optical links for analog applications.

An embodiment of the invention provides for means to reduce the noise figure and increase the gain in optical links for RF, signal processing and communications systems.

An embodiment of the invention provides for means to change the center frequency of an output demodulator of a phase modulated optical link.

### BRIEF DESCRIPTION OF THE DRAWINGS

FIG. 1 is a block diagram of a prior art externally-modulated optical link consisting of a CW laser, external modulator, delay and photodetector.

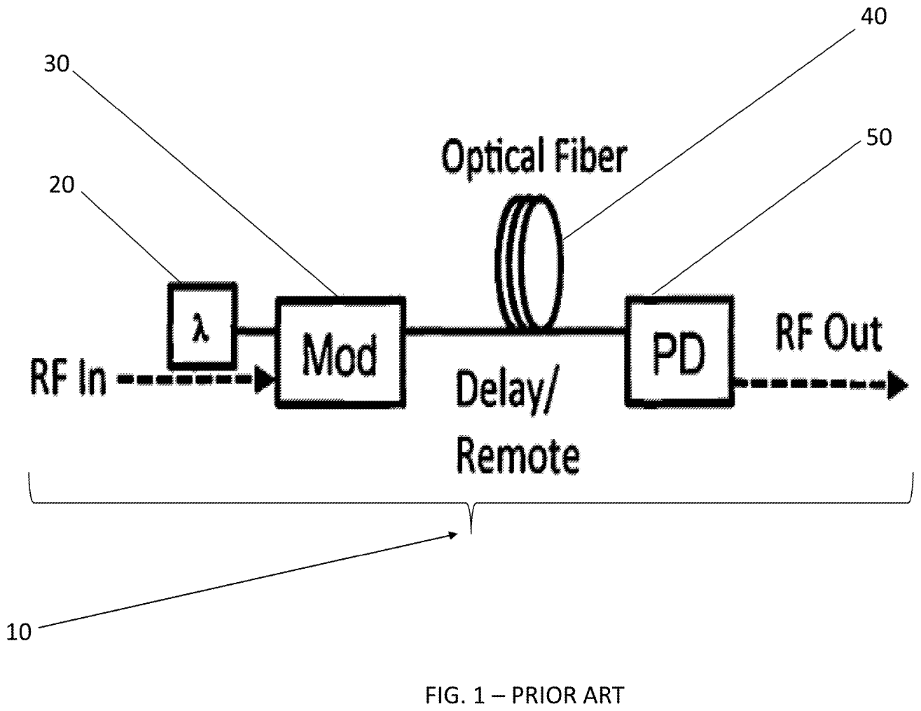

FIG. 2 is a block diagram of a prior art balanced optical link that utilizes the complementary outputs of dual-output modulator to balance (i.e., subtract) sources of common-mode laser relative intensity noise with a balanced photodetector.

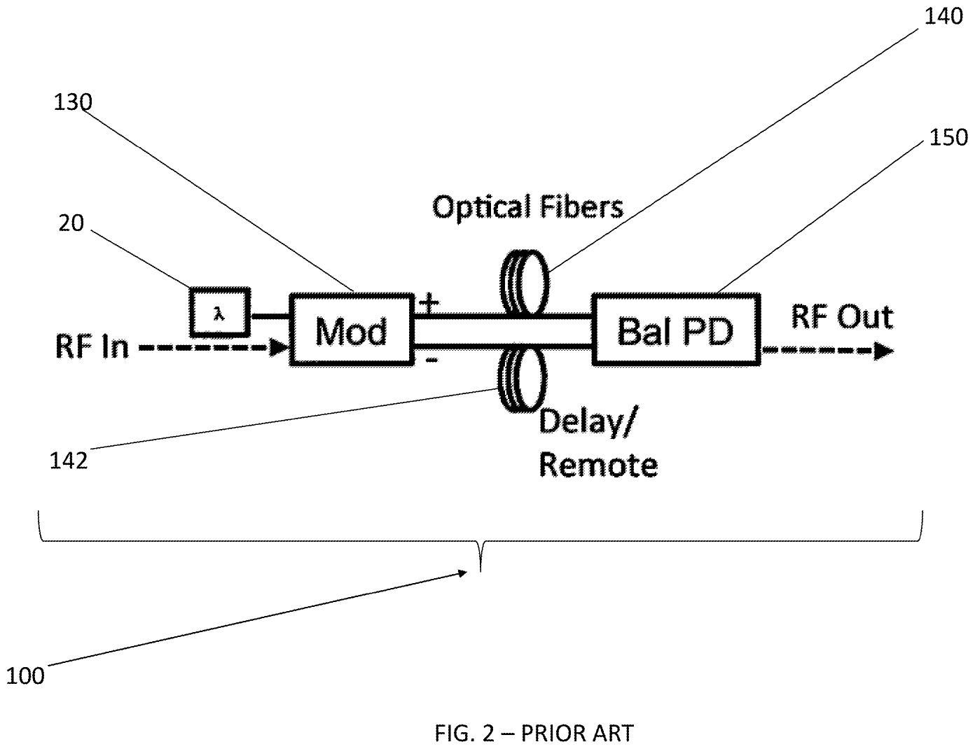

FIG. 3 is a block diagram of a prior art architecture for phase modulation with an unbalanced. Mach-Zehnder interferometer as a demodulator that converts phase to intensity modulation to facilitate detection and conversion back into RF.

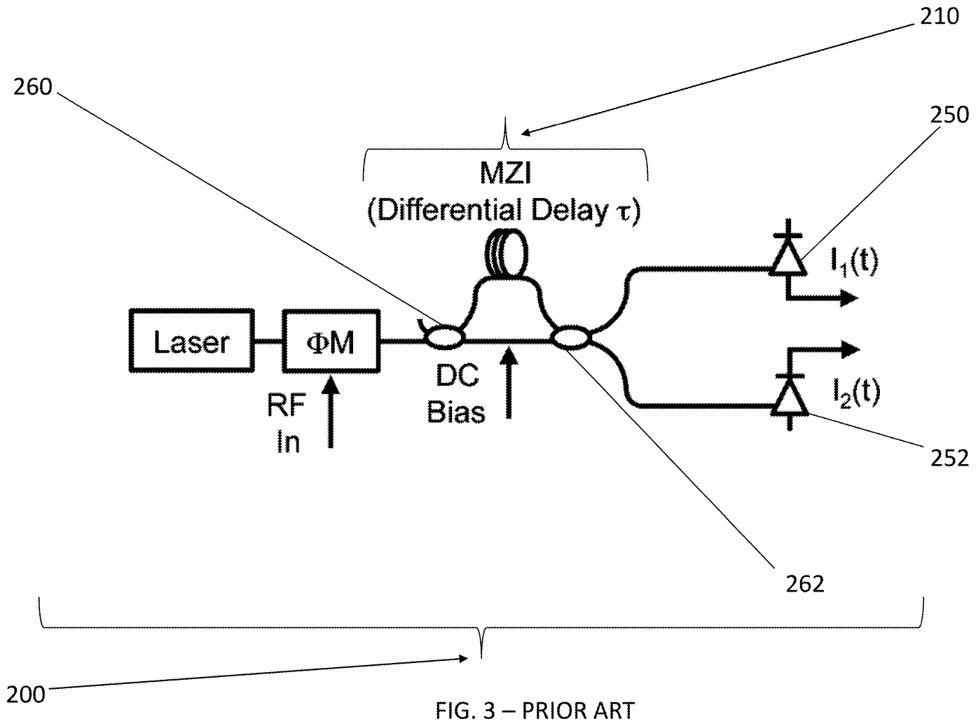

FIG. 4 is a schematic diagram of characteristics of a prior art 50/50 optical coupler, or splitter, such as used in the unbalanced Mach-Zehnder interferometer of FIG. 3.

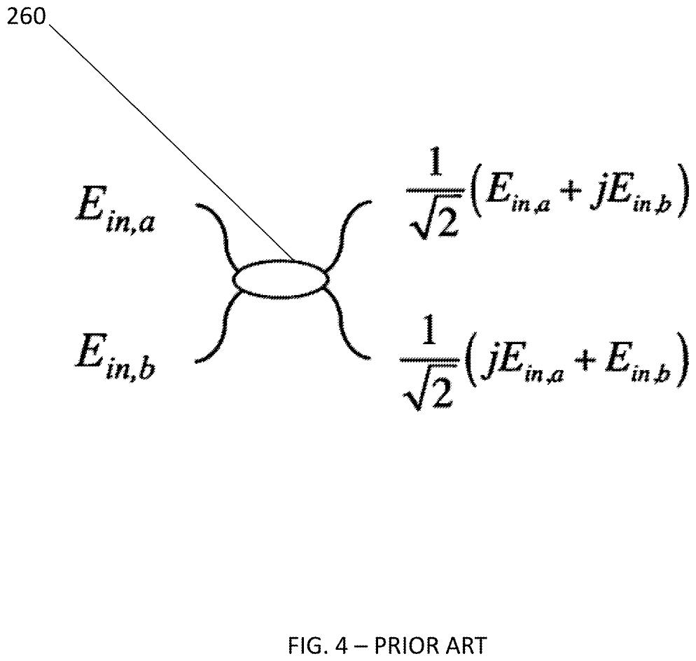

FIG. 5 is a block diagram of an embodiment of the invention including a phase modulated link with a dual-cavity Mach-Zehnder finite impulse response demodulator.

FIG. 6 is a block diagram of an embodiment of the invention including four adjustable Mach-Zehnder finite impulse response demodulators that allow for adjusting the center frequency and bandwidth of the demodulator. The exact passband characteristics are tuned by adjustment of the phase bias of the Mach-Zehnder via a quadrature control in each cavity.

FIG. 7 is a block diagram of an embodiment of the invention showing an illustrative implementation of a quadrature control function according to an embodiment of the invention, wherein output power in each output of the second optical coupler of each MZI demodulator is sampled with a small power tap (e.g., a low percentage coupler) and measured by a first photodiode and a second photodiode, and wherein Quadrature control₁ is a phase adjuster in one arm of the MZI and is adjusted to control the two output powers.

FIG. 8 is a block diagram of an embodiment of the invention including a phase modulated link with a selectable dual-cavity Mach-Zehnder finite impulse response demodulator through the setting of two optical switches.

### DETAILED DESCRIPTION OF THE INVENTION

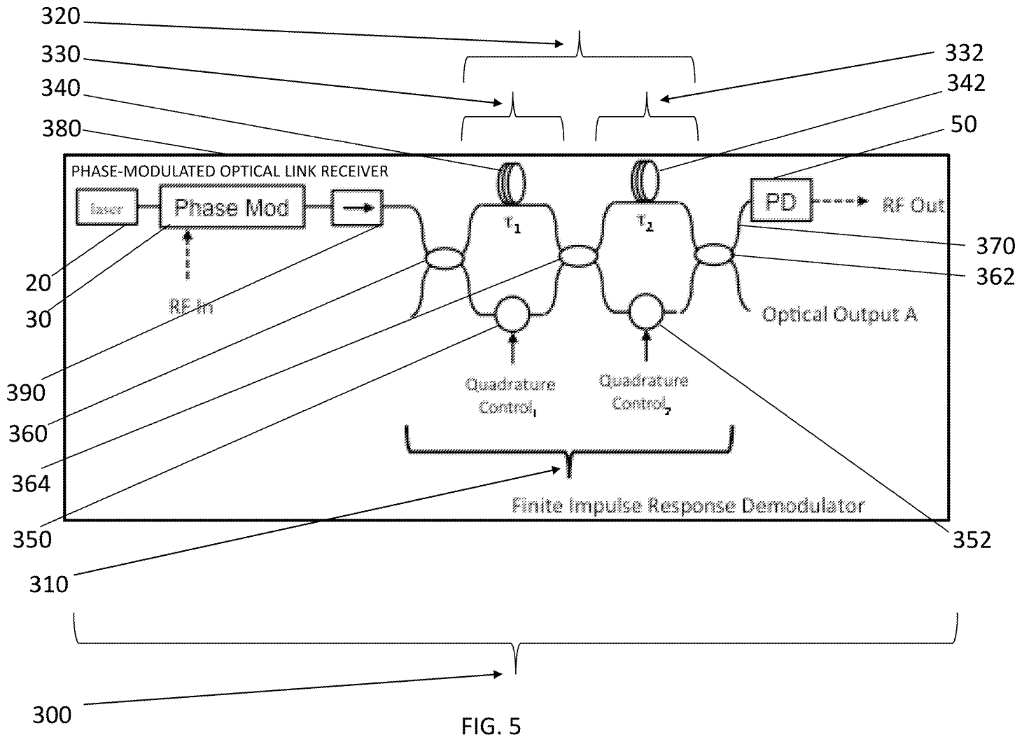

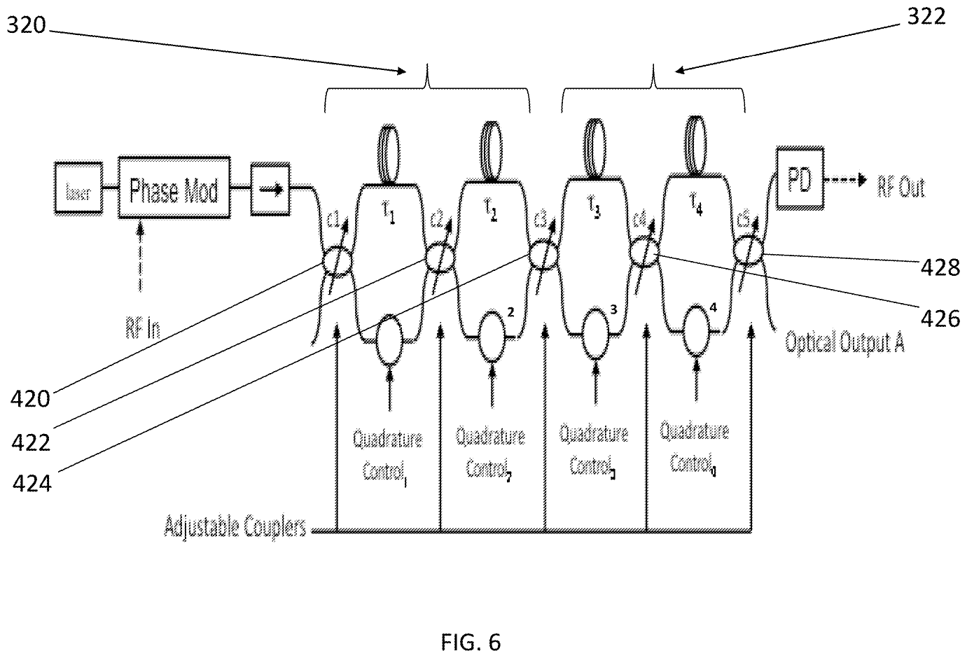

An embodiment of the invention includes an apparatus 300, such as shown by way of illustration in FIG. 5. The apparatus 300 includes a finite impulse response demodulator 310. The finite impulse response demodulator 310 comprising at least one stage (i.e., one or more stages) 320. FIG. 5, for example, shows an embodiment of the invention, wherein the at least one stage includes exactly one stage. Other embodiments of the invention, as discussed below, include more than one stage, such as shown in FIG. 6. Each stage of the at least one stage 320 includes a cascaded pair of standard interferometers. The cascaded pair of interferometers includes a first interferometer 330 and a second interferometer 332.

Optionally, the first interferometer 330 includes a standard first delay 340. The second interferometer 332 comprising a standard second delay 342. The first delay and the second delay are fixed or variable. Optionally, the first delay 340 is unequal to the second delay 342. Optionally, the first interferometer 330 includes standard first phase bias control 350. For the purpose of this patent application, “phase bias control” is a term of art and is defined as a device that monitors phase bias conditions in an interferometer and adjusts the phase bias of the interferometer via a quadrature control input. For example, the first phase bias control 350, for example, monitors a first phase bias within the first interferometer 330 and adjusts the first phase bias of the first interferometer 330 via a standard first quadrature control input. Optionally, the second interferometer includes standard second phase bias control 352. The second phase bias control 352 , for example, monitors a second phase bias within the second interferometer 332 and adjusts the second phase bias of the second interferometer 332 via a standard second quadrature control input.

Optionally, the first interferometer 330 includes a standard first fixed coupler 360 that splits the light into two paths. Optionally, the second interferometer 332 includes a standard second fixed coupler 362. The apparatus 300 further includes a third fixed coupler 364. The first fixed coupler 360 has a first coupling ratio, the second fixed coupler 363 has a second coupling ratio, and the third fixed coupler 364 has a third coupling ratio. Optionally, the second interferometer 332 includes a port 370. If the first coupling ratio, the second coupling ratio and the third coupling ratio each are 50%, then the first phase bias within the first interferometer and the second phase bias within the second interferometer are, for example, adjusted using the first phase bias control 350 and the second phase bias control 352, such that all optical power exits the port 370 of the second interferometer.

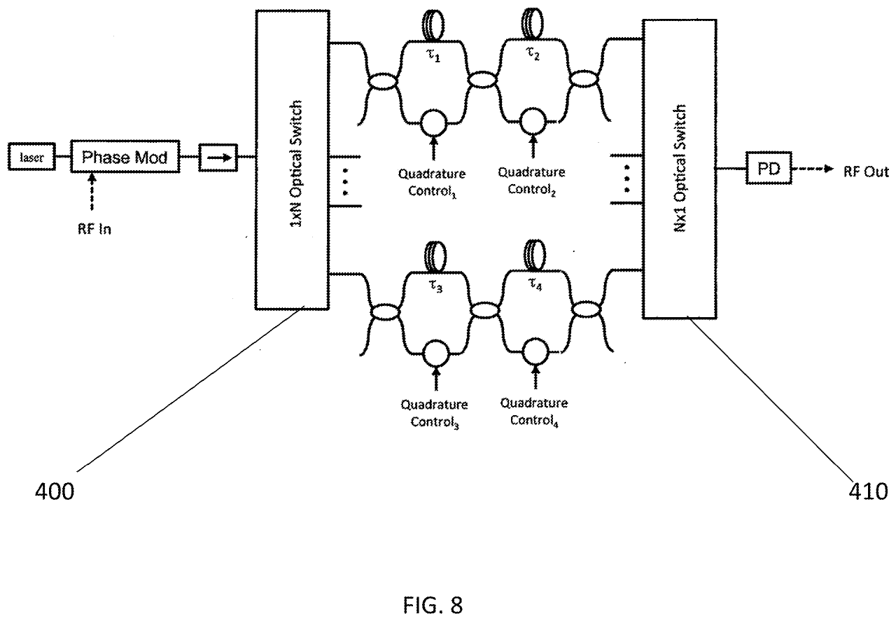

Optionally, the apparatus 300 further includes a standard photodiode 50 communicating with the finite impulse response demodulator 310. The at least one stage 320, 322 includes an optical output 370. The photodiode 50 detects the optical output 370 in entirety. Optionally, the apparatus 300 further includes a phase-modulated optical link receiver 380. The phase-modulated optical link receiver 380 includes a standard laser 20, a standard phase modulator 30 communicating with the laser 20, a standard isolator 390 communicating with the phase modulator 30. The finite impulse response demodulator 310 communicates with the isolator 390 and the photodiode 80. Optionally, as shown by way of illustration in FIG. 8, the apparatus 300 further includes a standard 1×N optical switch 400, communicating with the isolator 390 and with N number of finite impulse response demodulators 310. Optionally, as shown by way of illustration in FIG. 8, the apparatus 300 further includes a standard N×1 optical switch 410 communicating with N number of finite impulse response demodulators 310 and the photodiode 80.

Another embodiment of the invention is described as follows with reference, by way of illustration to FIG. 6. The embodiment of the invention includes standard adjustable couplers 420, 422, 424, 426, 428 (instead of standard fixed couplers, as found in the embodiment of the invention shown in FIG. 5). For example, first adjustable coupler 420 and second adjustable coupler 422 are adjusted such that all optical power bypasses, for example, the path with optical delay τ₁ of first interferometer 330, thus bypassing the first interferometer 330 in the serially connected cascaded pair of interferometers 320. As another example, third adjustable coupler 424, and/or fourth adjustable coupler 426 are adjusted such that all optical power bypasses, for example, the path with optical delay τ₂ of first interferometer 330, thus bypassing the first interferometer 330 in the serially connected cascaded pair of interferometers 320. As an additional example, first adjustable coupler 420, second adjustable coupler 422, third adjustable coupler 424, and/or fourth adjustable coupler 426 are adjusted such that all optical power from the first stage 320 bypasses the second stage 322 or such that all optical power bypasses the first stage 320 and passes to the second stage 322.

Optionally, the cascaded pair of interferometers 320 includes a cascaded pair of standard Mach-Zehnder interferometers, a cascaded pair of standard Fabry-Perot interferometers, a cascaded pair of standard Sagnac interferometers, or a cascaded pair of standard Michelson interferometers.

Another embodiment of the invention is described as follows with reference, by way of illustration, to FIG. 5. In this embodiment of the invention, a second cascaded unbalanced Mach-Zehnder interferometer (“MZI”) demodulator (or equivalently, additional Finite Impulse Response Filter, FIRF) is added to a first MZI demodulator to further narrow the instantaneous bandwidth. This has the benefit of directing all the light out of a single optical output towards a single photodiode, increasing the link gain and reducing the noise figure. To derive the small signal gain to determine the benefit, one starts with a cascade of two MZIs. The 2×2 matrix for the two electric field outputs is given by:

$$( \begin{matrix}{E}_{1} ( t ) \\ {E}_{2} ( t )\end{matrix} ) = \frac{1}{2 \sqrt{2}} ( \begin{matrix}1 & j \\ j & 1\end{matrix} ) ( \begin{matrix}{Γ}_{1} ( {τ}_{1} ) & 0 \\ 0 & 1\end{matrix} ) ( \begin{matrix}1 & j \\ j & 1\end{matrix} ) ( \begin{matrix}{Γ}_{2} ( {τ}_{2} ) & 0 \\ 0 & 1\end{matrix} ) ( \begin{matrix}1 & j \\ j & 1\end{matrix} ) ( \begin{matrix}{E}_{0} ( t ) \\ 0\end{matrix} ) \qquad ( 4 )$$

where τ₁ and τ₂ are the two delays in the MZIs. The electric field out of the upper arm of the output reduces to:

$${E}_{1} ( t ) = \frac{1}{2 \sqrt{2}} ( {Γ}_{1} {Γ}_{2} - {Γ}_{2} - {Γ}_{1} - 1 ) {E}_{0} ( t ) \qquad ( 5 )$$

For a general phase modulated input signal ϕ(t), the input electric field is given by: (6)

$${E}_{0} ( t ) = A {e}^{j ω t + ϕ ( t )} \qquad ( 6 )$$

where ω is the optical carrier frequency. The terms from Equation (5) can be written as:

$${E}_{0} ( t ) = {Ae}^{j ω t + ϕ ( t )} = {Ae}^{j ω t + a} , where a = ϕ ( t ) \qquad ( 7 )$$

$${Γ}_{1} {E}_{0} ( t ) = {Ae}^{j ω t - {ωτ}_{1} + ϕ ( t - {τ}_{1} )} = {Ae}^{j ω t + b} , where b = - {ωτ}_{1} + ϕ ( t - {τ}_{1} )$$

$${Γ}_{2} {E}_{0} ( t ) = {Ae}^{j ω t - {ωτ}_{2} + ϕ ( t - {τ}_{2} )} = {Ae}^{j ω t + c} , where c = - {ωτ}_{2} + ϕ ( t - {τ}_{2} )$$

$${Γ}_{1} {Γ}_{2} {E}_{0} ( t ) = {Ae}^{j ω t - ωτ ( {τ}_{1} + {τ}_{1} ) + ϕ ( t - {τ}_{1} - {τ}_{2} )} = {Ae}^{j ω t + d} ,$$

$$where d = - ω ( {τ}_{1} + {τ}_{2} ) + ϕ ( t - {τ}_{1} - {τ}_{2} )$$

This simplification allows Eqn. (5) to be written as:

$${E}_{1} ( t ) = \frac{A}{2 \sqrt{2}} ( {e}^{jd} - {e}^{jc} - {e}^{jb} - {e}^{ja} ) {e}^{j ω t} \qquad ( 8 )$$

The power output is proportional to the electric field multiplied by its complex conjugate and is equal to:

$${E}_{1} ( t ) {E}_{1}^{*} ( t ) = \frac{{A}^{2}}{8} ( {e}^{jd} - {e}^{jc} - {e}^{jb} - {e}^{ja} ) ( {e}^{- jd} - {e}^{- jc} - {e}^{- jb} - {e}^{- ja} ) \qquad ( 9 )$$

Multiplying this expression out and noting that:

e^{j(d-a)}+e^{j(a-d)}=2cos(a−d) (10)

yields:

$${E}_{1} ( t ) {E}_{1}^{*} ( t ) = \frac{{A}^{2}}{8} ( 4 - 2 cos ( d - c ) - 2 cos ( d - b ) - 2 cos ( d - a ) + 2 cos ( b - c ) + 2 cos ( c - a ) + 2 cos ( a - b ) ) \qquad ( 11 )$$

Looking at just one of the terms in Eqn. (11):

cos(c−d)=cos(ωτ₁+ϕ(t−τ₂)−ϕ(t−τ₂−τ₁))=cos(ωτ₁)cos(Δϕ)+sin (ωτ₁)sin(Δϕ); Δϕ=ϕ(t−τ₂)−ϕ(t−τ₂−τ₁) (12)

This is a general result. When the MZIs are biased such that, cos(ωτ)=0 and sin(ωτ)=1. This reduces Eqn. (12) to:

cos(c−d)=sin(Δϕ) (13)

The output photocurrent is proportional to EE*. When both MZIs are biased as above, Eqn. (11) reduces to:

$$I = {I}_{dc , q} ( 1 + \frac{1}{2} sin {Δϕ}_{1} + \frac{1}{2} sin {Δϕ}_{2} + \frac{1}{2} cos {Δϕ}_{3} - \frac{1}{2} cos {Δϕ}_{4} - \frac{1}{2} sin {Δϕ}_{5} - \frac{1}{2} sin {Δϕ}_{6} ) \qquad ( 14 )$$

where I_{dc,q} is the DC photocurrent and the expressions for the phase differences are defined as:

Δϕ₁=ϕ(t−τ₂)−ϕ(t−τ₂−τ₁) Δϕ₂=ϕ(t−τ₁)−ϕ(t−τ₂−τ₁) Δϕ₃=ϕ(t)−ϕ(t−τ₂−τ₁) Δϕ₄=ϕ(t−τ₁)−ϕ(t−τ₂) Δϕ₅=ϕ(t)−ϕ(t−τ₂) Δϕ₆=ϕ(t)−ϕ(t−τ₁) (15)

To reduce Eqn. (14), one first considers the last term and we make a time shift substitution:

sinΔϕ₆=sin(ϕ(t)−ϕ(t−τ₁))=sin(ϕ(t′+^{τ}½)−ϕ(t′−^{τ}½)) with t′=t−^{τ}½ (16)

when the input RF phase modulation waveform is a sinusoid at the frequency ω_{RF}:

ϕ(t)=Bsin(ω_{RF}1) (17)

with B the input amplitude, then Eqn. (16) reduces, with the help of trigonometric identities, to:

sinΔϕ₆=sin{2Bcos(ω_{RF}t′)sin(πfτ₁)} (18)

where ω_{RF}=2πf. Eqn. (18) can be further reduced with a Jacobi series to:

$$sin Δ {ϕ}_{6} = 2 {\sum }_{n = 0}^{∞} {( - 1 )}^{n} {J}_{2 n + 1} ( 2 B sin ( π f {τ}_{1} ) ) cos ( ( 2 n + 1 ) {ω}_{RF} ( t - {τ}_{1} / 2 ) ) \qquad ( 19 )$$

where J₂ₙ₊₁() are Bessel functions and the time substitution for t′ back to t has been made. Eqn. (19) is an odd function containing terms at the fundamental RE frequency and its odd harmonics. The term at the fundamental frequency is equal to:

$$sin {Δϕ}_{{6}_{fund}} = 2 {J}_{1} ( 2 B sin ( π f {τ}_{1} ) ) cos ( {ω}_{RF} ( t - {τ}_{1} / 2 ) ) \qquad ( 20 )$$

Each sinΔϕ term in Eqn. (14) will reduce to a similar expression. The cosΔϕ terms in Eqn. (14) similarly reduce, however those terms are even functions and do not contain totals at the fundamental RF frequency, rather they only contain terms at DC and even harmonics of ω_{RF} so those terms can be neglected for the gain calculation. A closer look at the four sin terms in Eqn. (14) reveal that two are proportional a common Bessel function and the other two are proportional to a different Bessel function. This reduces Eqn. (14) to:

$${I}_{fund} = {I}_{dc , q} \{ {J}_{1} ( 2 B sin ( π f {τ}_{1} ) ) [ cos ( {ω}_{RF} ( t - {τ}_{2} - {τ}_{1} / 2 ) ) - cos ( {ω}_{RF} ( t - {τ}_{1} / 2 ) ) ] + {J}_{1} ( 2 B sin ( π f {τ}_{2} ) ) [ cos ( {ω}_{RF} ( t - {τ}_{1} - {τ}_{2} / 2 ) ) - cos ( {ω}_{RF} ( t - {τ}_{2} / 2 ) ) ] \qquad ( 21 )$$

by using a time substitution of t″=t−τ₂/2−τ₁/2, the cosine terms can be further reduced and the desired end resulting equation is:

$${I}_{fund} = {I}_{dc , q} \{ 2 {J}_{1} ( 2 B sin ( π f {τ}_{1} ) ) sin ( π f {τ}_{2} ) + 2 {J}_{1} ( 2 B sin ( π f {τ}_{2} ) ) sin ( π f {τ}_{1} ) \} sin ( {ω}_{RF} ( t - {τ}_{1} / 2 - {τ}_{2} / 2 ) ) \qquad ( 22 )$$

The power gain is calculated by taking the time average of Eqn. (22), squaring and multiplying by the output resistance times the photodiode response function divided by the input RF power to the modulator (just as is done to derive Eqns. (1) and (2)). To express the result as the small signal gain, J₁(x)=x/2 for x<<1, which reduces Eqn. (22) to:

$${g}_{ss , doubleFIRF} = {{I}_{dc , q}^{2} ( \frac{4 π {I}_{dc , q} sin ( π f {τ}_{1} ) sin ( π f {τ}_{2} )}{{V}_{π}} )}^{2} {R}_{i} {R}_{o} {\vert {H}_{pd} \vert}^{2} \qquad ( 23 )$$

A close inspection of Eqn. (23) shows that if the two frequency-dependent sine terms are equal to one at the same time, then the small-signal power gain is 4 times the power gain of an intensity modulated link and 2 times the gain of the phase modulated link of FIG. 6. It achieves this by directing all the photocurrent out of a single optical output of the second FIRE (The DC current calculation can be done with a similar analysis as above but evaluating the cosine terms in Eqn. (14) under the same bias conditions.) The only condition is that the two sine functions peak at the same time which can occur with certainty if τ₁=τ₂, but even if the two τ's are unequal, the two sine functions can still peak at some frequency. For the case when the two time delays in the MZIs are equal, the link gain for this double-FIRE configuration is 12 dB higher than that of the intensity-modulated link. This result could have been anticipated with a closer look at Eqn. (14). Since the cosine terms in Eqn. (14) do not have a fundamental frequency component, the current in the fundamental is a sum of four sine terms that each have a weighting of ½, albeit with opposite signs. However, if the two positive sine terms can be made to he magnitude 1 and the two negative sine terms can be made to be magnitude −1, then the photocurrent at the fundamental frequency will be double that of the DC photocurrent, thus resulting in the 6 dB power gain over the PM link with a single MZI demodulator.

Because multiple MZIs with bias control in each MZI are not yet available, an embodiment of the invention includes MZIs from all fiber-based components with both containing the same delays τ₁=τ₂. Construction with these components makes it difficult to control the bias in the interferometers. The interferometers however are allowed to drift in and out of optimal bias due to natural environmental fluctuations. With a spectrum analyzer set to maximum hold position, the gain of the link varies, and it takes multiple sweeps to record the maximum gain, but it displays maximum gain, when the interferometers are optimally biased.

Optionally, the apparatus 300 further includes a standard laser with sub-kHz Lorenzian linewidth to achieve the shot noise limit without the deleterious effects of phase-to-intensity noise conversion within an MZI when the laser has wider linewidth.

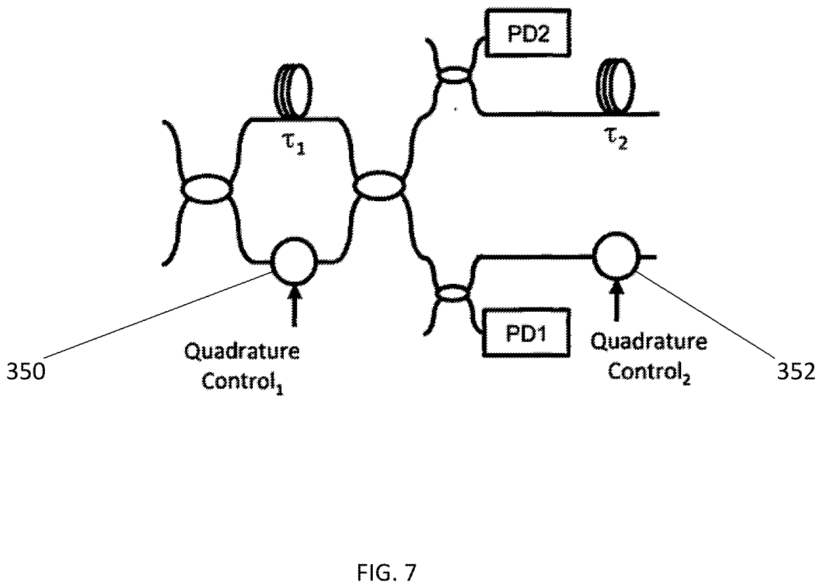

Optionally, in another embodiment of the invention, to maintain optimal bias, the apparatus 300 further includes a bias control mechanism in each interferometer. To implement a quadrature bias for each MZI, the first phase bias control 350 and second phase bias control 352, such as shown by way of illustration in FIG. 7 are used. A small percentage optical tap at both of the second coupler outputs in the MZI interferometer allows for a measurement of the power in each arm of the MZI. By controlling the amplitude balance at the output and feeding back to the quadrature control within the MZI, an optimal bias can be maintained. The quadrature condition for the first MZI with reasonable extinction (which can be calibrated out, even it is not high enough) is equal power at each output. The outputs of the second MZI (not shown in FIG. 7) also include these power taps to keep the optimal bias for the second MZI. In this case, however, the optimal bias is keeping the power maximized at one output and minimum at the other. The quadrature control element varies depending on the specific technology that the MZI is implemented in (such as fiber, planar lightwave, LiNbO3, or other optical integrated circuits platforms) but can be made to respond to a difference in power measurements from the two power taps. Other embodiments of the invention include other standard bias control mechanisms aside from DC power measurements; but, practical implementation include quadrature control on each MZI demodulator. Quadrature control according to the instant invention is implemented by standards techniques including, for example, measuring DC power levels and standard dithering techniques.

Optionally, another embodiment of the invention relates to tuning the bandwidth or center frequency of the dual MZI demodulator because the center frequency is determined by delays τ1 and τ2 in the interferometer. To allow for Wider bandwidths or to tune the bandwidth, a frequency-settable configuration can be utilized. As shown by way of illustration in FIG. 6, such a frequency-settable configuration includes cascading dual MZIs in series used in combination with optical couplers that can have an adjustable coupling ratio which allows the user to bypass all but the two particular MZIs used for the demodulation. To allow the first two MZIs to operate, first standard adjustable couplers 420, second standard adjustable coupler 422, and third standard adjustable coupler 424 are tuned to optimum bias for the delays T₁, τ₂ MZI while setting fourth standard adjustable coupler 426 and fifth standard adjustable coupler 428 to unity (i.e., 100% transmission). To change the center frequency, first adjustable coupler 420 and second adjustable coupler 422 are adjusted to unity (i.e., 100% transmission), and third adjustable coupler 424, fourth adjustable coupler 426, and fifth adjustable coupler 428 are tuned to optimum bias conditions for the delays τ₃, τ₄ MZI. Other embodiments of the invention include additional pairs of MZIs, if additional fixed center frequencies are desired.

Optionally, in another embodiment of the invention relates to tuning the bandwidth or center frequency of the dual MZI demodulator since the center frequency is determined by delays τ₁ and τ₂ in the interferometer. To allow for wider bandwidths or to tune the bandwidth a frequency settable configuration can be utilized. As shown by way of illustration in FIG. 8, this embodiment of the invention includes switching in different dual. MZIs with a standard 1×n switch 400 and a standard n×1 switch 410. The operation of this configuration is the same as a single dual MZI pair, however the exact pair can be switched in and out to change the center frequency.

Optionally, in another embodiment of the invention, as opposed to the cascade of 2×2 MZI demodulators described above, includes 3×3 MZI. demodulators or other larger matrix configurations of coherent optical lattice filters to tailor the transfer function. of the finite impulse response filter.

Although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of +10% of that stated.

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. An apparatus comprising:
a finite impulse response demodulator, said finite impulse response demodulator comprising at least one stage, each stage of said at least one stage comprising a cascaded pair of interferometers, said cascaded pair of interferometers comprises a first interferometer and a second interferometer.

2. The apparatus according to claim 1, wherein said first interferometer comprises a first delay, said second interferometer comprising a second delay, the first delay and the second delay being one of fixed or variable.

3. The apparatus according to claim 2, wherein said first delay is equal to said second delay.

4. The apparatus according to claim 2, wherein said first interferometer comprises a first phase bias control, said first phase bias control including a first quadrature control input, said first bias control monitoring a first phase bias within said first interferometer and adjusting the first phase bias,
wherein said second interferometer comprises a second phase bias control, said second phase bias control including a second quadrature control input, said second bias control monitoring the second phase bias within the second interferometer and adjusting the second phase bias.

5. The apparatus according to claim 4, wherein said first interferometer comprises a first adjustable coupler, said first adjustable coupler adjusting a first coupling ratio,
wherein said second interferometer comprises a second adjustable coupler, said second adjustable coupler communicating with said first interferometer, said second adjustable coupler adjusting a second coupling ratio.

6. The apparatus according to claim 5, wherein the first coupling ratio is 50%, and the second coupling ratio is 50%.

7. The apparatus according to claim 6, wherein said second interferometer comprises a port,
wherein, based on the first phase bias within said first interferometer and the second phase bias within said second interferometer, said first adjustable coupler and said second adjustable coupler bias said cascaded pair of interferometers such that all optical power exits said port of said second interferometer.

8. The apparatus according to claim 5, wherein said at least one stage comprises a plurality of stages, said plurality of stages comprising a first stage and a second stage, said second stage comprising:
a third adjustable coupler adjusting a third coupling ratio; and
a fourth adjustable coupler adjusting a fourth coupling ratio.

9. The apparatus according to claim 8, said first stage and said second stage being adjustably coupled using said first adjustable coupler, said second adjustable coupler, said third adjustable coupler, and said fourth adjustable coupler such that in a bypass mode one of all optical power from said first stage bypasses said second stage and the all optical power bypasses said first stage and passes to said second stage.

10. The apparatus according to claim 1, further comprising:
a photodiode communicating with said finite impulse response demodulator,
wherein said at least one stage comprises an optical output, said photodiode detecting the optical output in entirety.

11. The apparatus according to claim 10, further comprising:
a phase-modulated optical link receiver, said phase-modulated optical link receiver comprising:
a laser;
a phase modulator communicating with said laser;
an isolator communicating with said phase modulator;
said finite impulse response demodulator communicating with said isolator; and
said photodiode.

12. The apparatus according to claim 11, further comprising:
a 1×N switch communicating with said isolator and said finite impulse response demodulator; and
an N×1 switch communicating with said finite impulse response demodulator and said photodiode.

13. The apparatus according to claim 1, wherein said cascaded pair of interferometers comprises one of a cascaded pair of Mach-Zehnder interferometers, a cascaded pair of Fabry-Perot interferometers, a cascaded pair of Sagnac interferometers, and a cascaded pair of Michelson interferometers.
